(19) United States
(12) Patent Application Publication
(10) Pub. No.: US 2018/0233300 A1
(43) Pub. Date: Aug. 16, 2018

(54) ELECTRIC DOUBLE-LAYER CAPACITOR AND METHOD FOR MANUFACTURING THE SAME

(71) Applicant: Murata Manufacturing Co. Ltd., Nagaokakyo-shi (JP)

(72) Inventor: KEIJI HORIKAWA, Nagaokakyo-shi (JP)

(21) Appl. No.: 15/950,385

(22) Filed: Apr. 11, 2018

Related U.S. Application Data
(63) Continuation of application No. PCT/JP2016/080155, filed on Oct. 11, 2016.

(30) Foreign Application Priority Data
Nov. 4, 2015 (JP) 2015-216414

(51) Int. Cl. H01G 11/52; H01G 11/22; H01G 11/86; H01G 11/58; H01G 11/66

(52) U.S. Cl. CPC H01G 11/52; H01G 11/22; H01G 11/66; H01G 11/58; H01G 11/86

(57) ABSTRACT

An electric double-layer capacitor having a separator that contains polyacrylonitrile. An infrared absorption spectrum of the separator measured by a Fourier transform infrared spectrophotometer has a first peak in a range from 2240 cm⁻¹ to 2250 cm⁻¹ and a second peak in a range from 1580 cm⁻¹ to 1630 cm⁻¹. A ratio of an intensity of the second peak to an intensity of the first peak is 0.08 or more.

### CROSS REFERENCE TO RELATED APPLICATIONS

The present application is a continuation of International application No. PCT/JP2016/080155, filed Oct. 11, 2016, which claims priority to Japanese Patent Application No. 2015-216414, filed Nov. 4, 2015, the entire contents of each of which are incorporated herein by reference.

### FIELD OF THE INVENTION

The present invention relates to an electric double-layer capacitor and a method for manufacturing the electric double-layer capacitor.

### BACKGROUND OF THE INVENTION

Conventionally, capacitors are widely used in various electronic devices such as mobile phones. An electric double-layer capacitor (EDLC) is known as a capacitor. Since the electric double-layer capacitor does not involve a chemical reaction in charging and discharging, unlike the secondary battery, it has an advantage of having a long product life and an advantage that a large current can be charged and discharged in a short time. Accordingly, attempts have been made to apply electric double-layer capacitors to applications requiring a long product life, applications requiring a large current, and the like.

For example, Patent Document 1 describes an example of an electric double-layer capacitor. In the electric double-layer capacitor described in Patent Document 1, a nonwoven fabric separator is provided between a positive electrode and a negative electrode.

Patent Document 1: Japanese Patent Application Laid-Open No. 2006-278896

### SUMMARY OF THE INVENTION

Incidentally, in recent years, downsizing and thinning of electronic devices have progressed. With this, there is a demand to thin an electric double-layer capacitor.

A main object of the present invention is to provide a thin electric double-layer capacitor.

An electric double-layer capacitor according to the present invention includes a positive electrode, a negative electrode, and a separator. The positive electrode has a positive electrode side current collecting electrode and a positive electrode side polarizable electrode. The positive electrode side polarizable electrode is provided on the positive electrode side current collecting electrode. The negative electrode is opposed to the positive electrode. The negative electrode has a negative electrode side current collecting electrode and a negative electrode side polarizable electrode. The negative electrode side polarizable electrode is provided on the negative electrode side current collecting electrode. The separator is interposed between the positive electrode side polarizable electrode and the negative electrode side polarizable electrode. The separator is impregnated with an electrolyte. The positive electrode and the negative electrode are arranged such that at least one set of edge sides corresponding to each other are different in a position in a plan view. The separator contains polyacrylonitrile. An infrared absorption spectrum of the separator measured by a Fourier transform infrared spectrophotometer has a first peak in a range from 2240 cm⁻¹ to 2250 cm⁻¹ and a second peak in a range from 1580 cm⁻¹ to 1630 cm⁻¹. A ratio of an intensity of the second peak to an intensity of the first peak is 0.08 or more.

In the electric double-layer capacitor according to the present invention, since the ratio of the intensity of the second peak to the intensity of the first peak is 0.08 or more, a mechanical strength of the separator is high. In the electric double-layer capacitor according to the present invention, the positive electrode and the negative electrode are arranged such that at least one set of edge sides corresponding to each other are in a different position in a plan view. For this reason, it is possible to suppress concentration of stress on specific portions of the separator. Therefore, the mechanical strength required for the separator is low. Accordingly, the separator can be thinned. Therefore, it is possible to reduce a thickness of the electric double-layer capacitor.

In the electric double-layer capacitor according to the present invention, it is preferred that the positive electrode and the negative electrode are arranged such that in a plan view, one set of edge sides corresponding to each other are in different positions, and the other set of edge sides corresponding to each other which are parallel to the one set of edge sides are in different positions. In this case, the mechanical strength required for the separator is lower. Therefore, the separator can be made thinner. As a result, it is possible to further reduce the thickness of the electric double-layer capacitor.

In the electric double-layer capacitor according to the present invention, it is preferred that the positive electrode and the negative electrode are arranged such that in a plan view, each set of edge sides corresponding to each other are in different positions. In this case, the mechanical strength required for the separator is further reduced. Therefore, the separator can be further thinned. As a result, it is possible to further reduce the thickness of the electric double-layer capacitor.

In the electric double-layer capacitor according to the present invention, the separator is preferably larger than the positive electrode and the negative electrode.

In the electric double-layer capacitor according to the present invention, a maximum thickness of the separator is preferably 11 μm to 26 μm.

A method for manufacturing an electric double-layer capacitor according to the present invention includes: heating a separator containing polyacrylonitrile; laminating a positive electrode, the heated separator, and a negative electrode such that edge side positions on at least the same side of the positive electrode and the negative electrode are different from each other in a plan view to prepare a laminated body; and impregnating the heated separator with an electrolyte.

In the method for manufacturing an electric double-layer capacitor according to the present invention, the separator containing polyacrylonitrile is heated. Therefore, the mechanical strength of the separator can be increased. Further, the positive electrode, the heated separator, and the negative electrode are laminated such that edge side positions on at least the same one side of the positive electrode and the negative electrode are different from each other in a plan view. Therefore, when an external stress is applied to the produced electric double-layer capacitor, the stress hardly concentrates at a specific location of the separator. Therefore, the mechanical strength required for the separator is low. Therefore, the separator can be thinned. As a result, a thin electric double-layer capacitor can be manufactured.

According to the present invention, it is possible to provide a thin electric double-layer capacitor.

### BRIEF EXPLANATION OF THE DRAWINGS

FIG. 1 is a schematic cross-sectional view of an electric double-layer capacitor according to a first embodiment.

FIG. 2 is a schematic plan view of a main part of the electric double-layer capacitor according to the first embodiment.

FIG. 3 is a schematic plan view of a negative electrode in the first embodiment.

FIG. 4 is a schematic plan view of a positive electrode in the first embodiment.

FIG. 5 is a schematic plan view of an electric double-layer capacitor according to a second embodiment.

FIG. 6 is a schematic plan view of a negative electrode in the second embodiment.

FIG. 7 is a schematic plan view of a positive electrode in the second embodiment.

FIG. 8 is an infrared absorption spectrum of a separator prepared in each of Examples 1 and 2 and comparative example.

### DETAILED DESCRIPTION OF THE INVENTION

Hereinafter, examples of preferred embodiments of the present invention will be described. However, the following embodiments are merely an exemplification. The present invention is not limited to the following embodiments at all.

Further, the drawings referred to in the embodiments or the like are schematically shown. Dimensional ratios and the like of objects pictured in the drawings may be different from those of real objects. The dimensional ratios and the like of an object may differ between drawings. The dimensional ratios and the like of specific objects have to be determined in consideration of the following description.

### First Embodiment

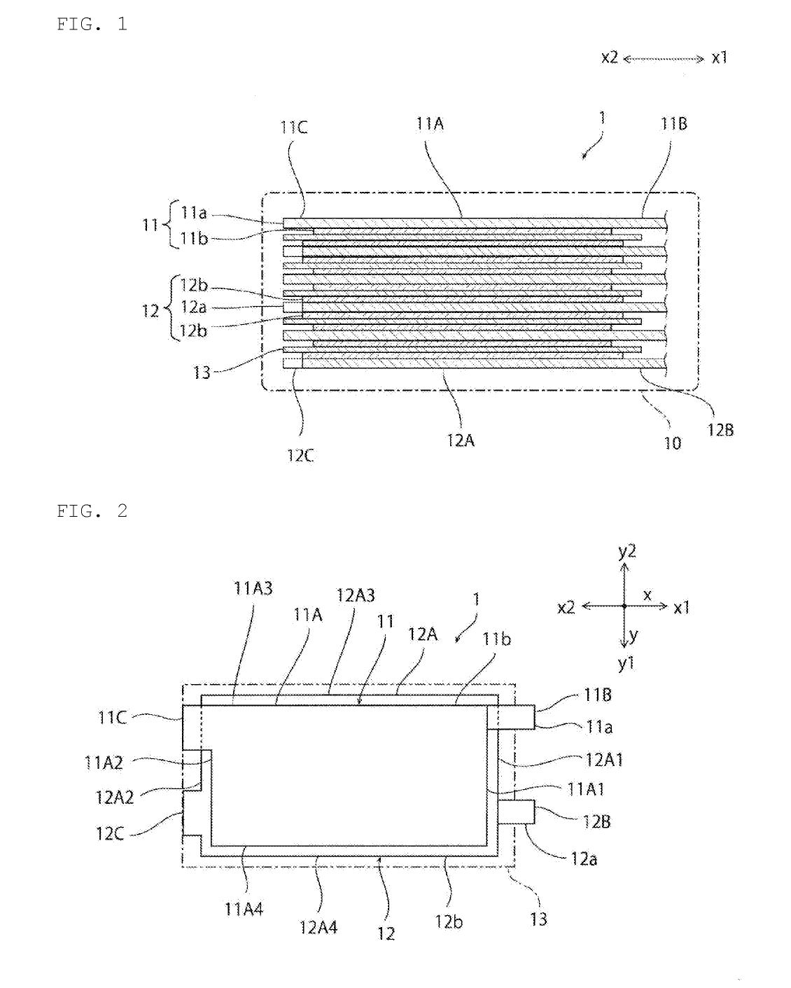

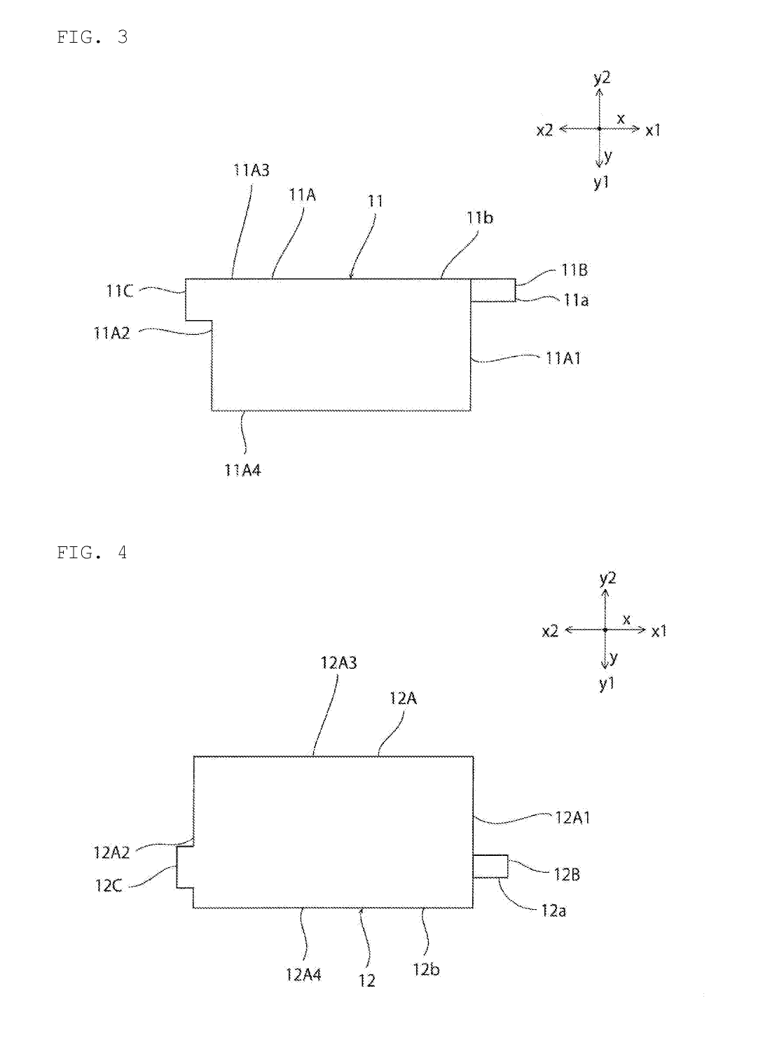

FIG. 1 is a schematic cross-sectional view of an electric double-layer capacitor according to the present embodiment. FIG. 2 is a schematic plan view of a main part of the electric double-layer capacitor according to the present embodiment. In FIG. 2, illustration of an outer case 10 is omitted.

As shown in FIG. 1, the electric double-layer capacitor 1 has a first electrode 11, a second electrode 12, a separator 13, and an outer case 10.

The first electrode 11 and the second electrode 12 are opposed to each other with the separator 13 interposed therebetween. Specifically, a plurality of first electrodes 11 and a plurality of second electrodes 12 are alternately laminated with the separator 13 interposed therebetween. The first electrodes 11 are electrically connected to each other by a first extended terminal (not shown), and is extended to the outside of the outer case 10. The second electrodes 12 are electrically connected to each other by a second extended terminal (not shown), and is extended to the outside of the outer case 10.

(First Electrode 11)

The first electrode 11 has a first current collecting electrode 11a. The first current collecting electrode 11a can be formed of, for example, an aluminum foil or the like. A thickness of the first current collecting electrode 11a can be, for example, about 10 μm or more and 30 μm or less.

A first polarizable electrode 11b is provided on the first current collecting electrode 11a. Specifically, in the first current collecting electrode 11a, located at an outermost position in a thickness direction (laminating direction), of the second electrode 12 and the first electrode 11, a first polarizable electrode 11b is provided only on an inner main surface and the first polarizable electrode 11b is not provided on an outer main surface. In the other first electrode 11, the first polarizable electrode 11b is provided on both main surfaces of the first current collecting electrode 11a. That is, the first polarizable electrode 11b is provided only on a main surface opposed to the second electrode 12 of the main surface of the first current collecting electrode 11a. A thickness of the first polarizable electrode 11b can be, for example, about 10 μm or more and 30 μm or less.

As shown in FIGS. 2 and 3, the first electrode 11 has a rectangular positive electrode 11A, an extended part 11B, and a non-opposing part 11C. The positive electrode 11A is opposed to the second electrode 12. The positive electrode 11A has a first current collecting electrode (positive electrode side current collecting electrode) 11a and a first polarizable electrode (positive electrode side polarizable electrode) 11b provided on the first current collecting electrode 11a. The first polarizable electrode 11b is provided only on the positive electrode 11A and the non-opposing part 11C of the first electrode 11.

As shown in FIG. 3, the positive electrode 11A has a first side 11A1 and a second side 11A2 extending along the y-axis direction (first direction). The positive electrode 11A has a third side 11A3 and a fourth side 11A4 extending along the x-axis direction (second direction).

The extended part 11B is connected to the positive electrode 11A. Specifically, in the present embodiment, the extended part 11B extends from a portion on the y2 side in the y-axis direction perpendicular to the x-axis direction to the x1 side in the positive electrode 11A. The extended part 11B is formed of the first current collecting electrode 11a.

The non-opposing part 11C is connected to the positive electrode 11A. Specifically, in this embodiment, the non-opposing part 11C extends from the portion on the y2 side in the y-axis direction perpendicular to the x-axis direction to the x2 side in the positive electrode 11A. The non-opposing part 11C is a portion which is not opposed to the negative electrode 12A, which will be described later, in the laminating direction. In the present embodiment, the first electrode 11 has one non-opposing part 11C. The non-opposing part 11C is formed of the first current collecting electrode 11a and the first polarizable electrode 11b.

In the present embodiment, an example in which the non-opposing part 11C is provided is described, but the present invention is not limited to this configuration. For example, the first electrode may be formed of a positive electrode and an extended part.

(Second Electrode 12)

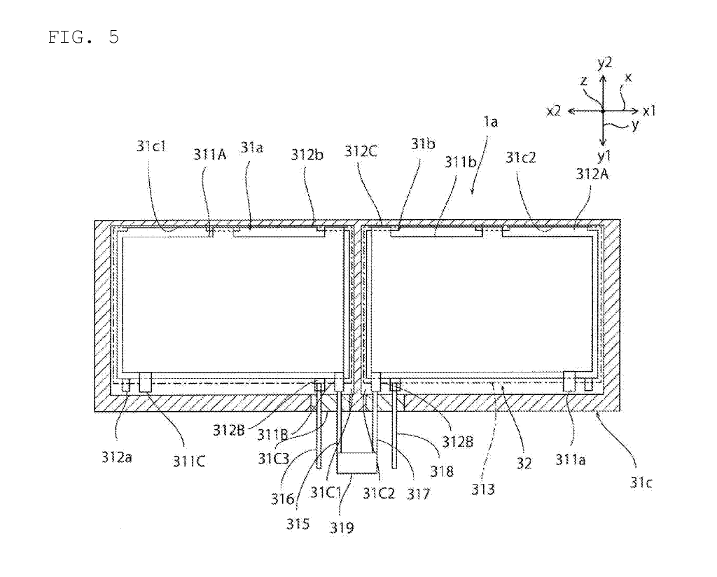

As shown in FIGS. 1 and 4, the second electrode 12 includes a second current collecting electrode 12a. The second current collecting electrode 12a can be formed of, for example, an aluminum foil or the like. A thickness of the second current collecting electrode 12a can be, for example, about 10 μm or more and 30 μm or less.

A second polarizable electrode 12b is provided on the second current collecting electrode 12a. Specifically, in the second current collecting electrode 12a, located at an outermost position in a thickness direction (laminating direction), of the second electrode 12 and the first electrode 11, a second polarizable electrode 12b is provided only on an inner main surface and the second polarizable electrode 12b is not provided on an outer main surface. In the other second electrode 12, the second polarizable electrode 12b is provided on both main surfaces of the second current collecting electrode 12a. That is, the second polarizable electrode 12b is provided only on a main surface opposed to the first electrode 11 of the main surface of the second current collecting electrode 12a. A thickness of the second polarizable electrode 12b can be, for example, about 10 μm or more and 30 μm or less.

As shown in FIG. 1 and FIG. 4, the second electrode 12 has a rectangular negative electrode 12A, an extended part 12B, and a non-opposing part 12C. The negative electrode 12A is opposed to the positive electrode 11A. Specifically, at least a portion of the negative electrode 12A is opposed to the positive electrode 11A. The negative electrode 12A has a second current collecting electrode (negative electrode side current collecting electrode) 12a and a second polarizable electrode (negative electrode side polarizable electrode) 12b provided on the second current collecting electrode 12a. The second polarizable electrode 12b is provided only on the negative electrode 12A and the non-opposing part 12C of the second electrode 12.

As shown in FIG. 4, the negative electrode 12A has a first side 12A1 and a second side 12A2 extending along the y-axis direction (first direction). The negative electrode 12A has a third side 12A3 and a fourth side 12A4 extending along the x-axis direction (second direction).

In the present embodiment, the negative electrode 12A is larger than the positive electrode 11A. In other words, the negative electrode 12A has a larger area than the positive electrode 11A. An area of the negative electrode 12A is preferably 1.0 times or more larger than an area of the positive electrode 11A, and is preferably 1.5 times or less, more preferably 1.01 times or more and 1.3 times or less. If a difference between the area of the negative electrode 12A and the area of the positive electrode 11A is too large, a capacitance of the electric double-layer capacitor 1 may be reduced. If the difference between the area of the negative electrode 12A and the area of the positive electrode 11A is too small, a deterioration at the time of voltage application may become faster in some cases.

As described above, since the negative electrode 12A has a larger area than the positive electrode 11A, at least one set of edge sides of the positive electrode 11A and the negative electrode 12A corresponding to each other are different in a position in a plan view. Specifically, in the present embodiment, in a plan view, one set of edge sides corresponding to each other are different in a position, and the other set of edge sides corresponding to each other which are parallel to the one set of edge sides are different in a position. That is, the positions of the first side 11A1 of the positive electrode 11A and the first side 12A1 of the negative electrode 12A are different, the positions of the second side 11A2 of the positive electrode 11A and the second side 12A2 of the negative electrode 12A are different or the positions of the third side 11A3 of the positive electrode 11A and the third side 12A3 of the negative electrode 12A are different, and the positions of the fourth side 11A4 of the positive electrode 11A and the fourth side 12A4 of the negative electrode 12A are different. More specifically, the positive electrode 11A and the negative electrode 12A are provided such that in a plan view, each set of edge sides corresponding to each other are different in a position. That is, the positive electrode 11A and the negative electrode 12A are provided such that the positions of the first side 11A1 and the first side 12A1 are different, the positions of the second side 11A2 and the second side 12A2 are different, the positions of the third side 11A3 and the third side 12A3 are different, and the positions of the fourth side 11A4 and the fourth side 12A4 are different.

In the present embodiment, an example in which the positive electrode 11A has a smaller area than the negative electrode 12A will be described. However, the present invention is not limited to this configuration. For example, the negative electrode may have a smaller area than the positive electrode, or an area of the negative electrode may be the same as an area of the positive electrode.

In the present invention, the term “the edge sides corresponding to each other” means one edge side of the positive electrode and one edge side of the negative electrode which are parallel to each other and closest to each other.

The extended part 12B is connected to the negative electrode 12A. Specifically, in the present embodiment, the extended part 12B extends from the portion on the y1 side in the y-axis direction to the x1 side in the negative electrode 12A. The extended part 12B is formed of the second current collecting electrode 12a.

The non-opposing part 12C is connected to the negative electrode 12A. The non-opposing part 12C extends from the negative electrode 12A to the x2 side in the x-axis direction. Specifically, in the present embodiment, the non-opposing part 12C extends from the portion on the y1 side in the y-axis direction to the x2 side in the negative electrode 12A. The non-opposing part 12C is a portion not opposed to the positive electrode 11A in the laminating direction. In the present embodiment, the second electrode 12 has one non-opposing part 12C. The non-opposing part 12C is formed of a second current collecting electrode 12a and a second polarizable electrode 12b.

In the present embodiment, an example in which the non-opposing part 12C is provided has been described, but the present invention is not limited to this configuration. For example, the second electrode may be formed of a negative electrode and an extended part.

(Separator 13)

As shown in FIG. 1, the separator 13 is provided between the first electrode 11 and the second electrode 12 which are neighboring. Specifically, the separator 13 is interposed between the first polarizable electrode 11b and the second polarizable electrode 12b which are neighboring. In the present embodiment, the separator 13 is larger than the positive electrode 11A and the negative electrode 12A. The first electrode 11 and the second electrode 12 are isolated from each other by this separator 13.

A maximum thickness of the separator 13 is preferably 11 μm or more, and more preferably 15 μm or more. By setting the maximum thickness of the separator 13 in the above range, it is possible to prevent a short-circuit failure from occurring when stress is applied to the electric double-layer capacitor 1. However, if the maximum thickness of the separator 13 is made too large, an internal resistance of the electric double-layer capacitor 1 may increase. Therefore, the maximum thickness of the separator 13 is preferably 26 μm or less, and more preferably 20 μm or less. For the maximum thickness of the separator 13, arbitrary five points were measured with a micrometer C125 XB manufactured by Mitutoyo Corporation, and the maximum value among them was taken as the maximum thickness.

The separator 13 can be formed of, for example, a porous sheet having a plurality of interconnected cells. A void ratio of the separator 13 is preferably 70% or more, and more preferably 80% or more. By setting the void ratio of the separator 13 within the above range, an internal resistance of the electric double-layer capacitor 1 can be reduced. However, when the void ratio of the separator 13 is set too high, a short-circuit failure easily occurs when an external stress is applied to the electric double-layer capacitor 1. Therefore, the void ratio of the separator 13 is preferably 95% or less, and more preferably 90% or less.

The void ratio of the separator 13 can be measured in the following manner. First, the separator is washed with water to remove an adhered electrolyte, and then is dried, and a weight and an area of the separator are measured, and the measured weight is divided by the area to determine an areal weight (g/m²). From the areal weight and the maximum thickness of the above measurement, the void ratio (%) was calculated by the following formula.

Void ratio (%)=[1−(areal weight/maximum thickness/material density of substrate)]×100

The separator 13 can be formed of, for example, a material that is a nonwoven fabric, a woven fabric, or the like. When the separator 13 is formed of a nonwoven fabric or a woven fabric, an average fiber diameter of the fibers of the nonwoven fabric or the woven fabric is preferably 0.5 μm or less, and more preferably 0.45 μm or less. By setting the average fiber diameter within the above range, the internal resistance of the electric double-layer capacitor 1 can be reduced. However, when the average fiber diameter is too small, a mechanical strength of the separator 13 may be lowered. Therefore, the average fiber diameter is preferably 0.2 μm or more, more preferably 0.25 μm or more.

The material of the separator 13 contains polyacrylonitrile (PAN). Preferably, the polyacrylonitrile in in fiber form. The material of the separator 13 may further contain components other than polyacrylonitrile. The material of the separator 13 may further contain, for example, a thermally modified product of polyacrylonitrile, polyethylene terephthalate (PET), polyvinyl alcohol (PVA), aramid or the like.

An infrared absorption spectrum of the separator 13 measured by a microscopic transmission method with a Fourier transform infrared spectrophotometer has a first peak in a range from 2240 cm⁻¹ to 2250 cm⁻¹. In addition, the infrared absorption spectrum of the separator 13 measured by a Fourier transform infrared spectrophotometer has a second peak in the range of 1580 cm⁻¹ to 1630 cm⁻¹. A ratio of an intensity of the second peak to an intensity of the first peak is 0.08 or more.

In the present invention, an intensity of a peak is a value measured using a straight line passing through a point of 950 cm⁻¹ and a point of 2500 cm⁻¹ of the infrared absorption spectrum as a baseline.

(Outer Case 10)

The first electrode 11, the second electrode 12, and the separator 13 are housed in the outer case 10. The first electrode 11 is connected to a first extended terminal (not shown) provided outside the outer case 10. The second electrode 12 is connected to a second extended terminal (not shown) provided outside the outer case 10. The outer case 10 can be formed of, for example, a stainless laminate sheet, an aluminum laminate sheet or the like, both surfaces of which are covered with a resin layer.

(Electrolyte)

An electrolyte is interposed between the first electrode 11 and the second electrode 12. Specifically, the separator 13 interposed between the first polarizable electrode 11b of the first electrode 11 and the second polarizable electrode 12b of the second electrode 12 is impregnated with the electrolyte.

The electrolyte includes a cation, an anion, and a solvent. Preferable examples of the cation include tetraethylammonium salt, triethylmethylammonium, 5-azoniaspiro[4,4]nonane, and the like. Preferable examples of the anion include tetrafluoroborate ions (BF₄⁻), bis[(trifluoromethyl)sulfonyl]imide ((CF₃SO₂)₂N⁻), and the like. Preferable examples of the solvent include carbonate compounds such as propylene carbonate, ethylene carbonate, diethyl carbonate, and dimethyl carbonate; nitrile compounds; and aqueous solvents such as water.

The electrolyte may be, for example, an ionic liquid containing a crosslinkable gel electrolyte or an imidazole compound.

(Manufacturing Method for Electric Double-Layer Capacitor 1)

In manufacturing the electric double-layer capacitor 1, first, the first and second electrodes 11, 12 and the separator 13 are prepared.

The separator 13 is one in which the infrared absorption spectrum has a first peak in a range from 2240 cm⁻¹ to 2250 cm⁻¹ and a second peak in a range from 1580 cm⁻¹ to 1630 cm⁻¹, and the ratio of the intensity of the second peak to the intensity of the first peak is 0.08 or more. This separator 13 can be prepared by heating a porous sheet (separator) containing polyacrylonitrile. A heating temperature of the porous sheet is preferably 210° C. or higher, and more preferably 225° C. or higher. The heating temperature of the porous sheet is preferably 300° C. or lower, and more preferably 245° C. or lower. By setting the heating temperature of the porous sheet to the above temperature, it is easy to make the ratio of the intensity of the second peak to the intensity of the first peak 0.08 or more. A heating time of the porous sheet is preferably 20 seconds or more, more preferably 40 seconds or more, and still more preferably 45 seconds or more. By setting the heating time of the porous sheet to the above-mentioned time, it is easy to make the ratio of the intensity of the second peak to the intensity of the first peak 0.08 or more. However, when the heating time of the porous sheet is too long, the mechanical strength of the separator 13 may be lowered in some cases. Therefore, the heating time of the porous sheet is preferably 150 seconds or less, and more preferably 130 seconds or less.

Next, the first electrode 11, the separator 13, and the second electrode 12 are laminated such that edge side positions on at least the same one side of the positive electrode 11A and the negative electrode 12A are different from each other in a plan view to prepare a laminated body.

Next, the separator 13 is impregnated with an electrolyte. Specifically, after inserting the laminated body into the outer casing 10, an electrolyte is supplied into the outer case 10 to impregnate the separator 13 with the electrolyte.

Finally, the outer case 10 is sealed, and the electric double-layer capacitor 1 can be completed.

As a result of intensive research, the present inventors have found that by setting the ratio of the intensity of the second peak to the intensity of the first peak in the infrared absorption spectrum of the separator 13 containing polyacrylonitrile to 0.08 or more, the mechanical strength of the separator 13 can be improved, and therefore a desired mechanical strength can be attained even if the separator 13 is thinned. As a result, the present inventors conceived that by setting the ratio of the intensity of the second peak to the intensity of the first peak in the infrared absorption spectrum of the separator 13 containing polyacrylonitrile to 0.08 or more, the separator 13 can be thinned, and therefore it is possible to reduce a thickness of the electric double-layer capacitor 1.

Furthermore, in the electric double-layer capacitor 1, the positive electrode 11A and the negative electrode 12A are arranged such that at least one set of edge sides corresponding to each other are different in a position in a plan view. Therefore, when an external stress is applied to the electric double-layer capacitor 1, the stress hardly concentrates at a specific location of the separator 13. Therefore, the mechanical strength required for the separator 13 is low as compared with the case where the stress concentrates at a specific location of the separator. Therefore, the separator 13 can be thinned. As a result, the electric double-layer capacitor 1 can be made thinner.

From the viewpoint of more effectively suppressing the concentration of stress at a specific location of the separator 13 when an external stress is applied to the electric double-layer capacitor 1, it is more preferred that the positive electrode 11A and the negative electrode 12A are arranged such that in a plan view, one set of edge sides corresponding to each other are different in a position, and the other set of edge sides corresponding to each other which are parallel to the one set of edge sides are different in a position. From the same viewpoint, it is more preferred that the positive electrode 11A and the negative electrode 12A are arranged such that in a plan view, each set of edge sides corresponding to each other are different in a position.

In addition, the present inventors have found that the separator 13 containing polyacrylonitrile in which the ratio of the intensity of the second peak to the intensity of the first peak in the infrared absorption spectrum is 0.08 or more is high in thermal durability, and is hardly modified at high temperature. As a result, the present inventors conceived that by setting the ratio of the intensity of the second peak to the intensity of the first peak in the infrared absorption spectrum of the separator 13 containing polyacrylonitrile to 0.08 or more, an electric double-layer capacitor 1 having excellent thermal durability can be realized.

Hereinafter, another example of a preferred embodiment of the present invention will be described. In the following description, a member having a function substantially common to that of the first embodiment is denoted by the same symbol, and descriptions of the member will be omitted.

### Second Embodiment

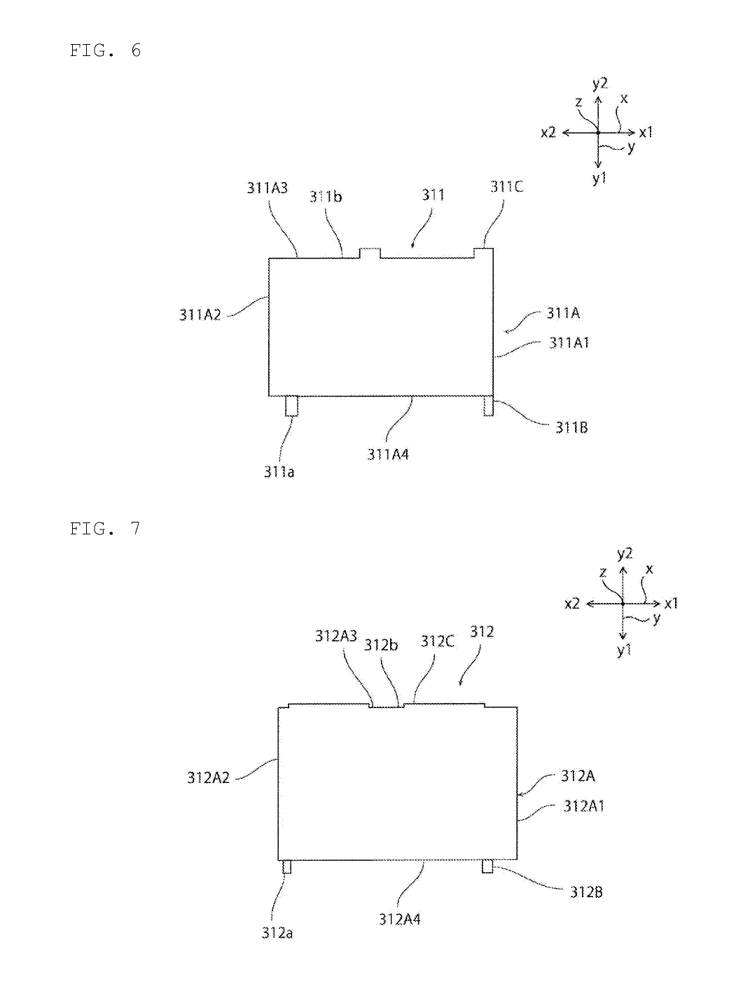

FIG. 5 is a schematic plan view of an electric double-layer capacitor 1a according to the present embodiment.

In the present embodiment, the electric double-layer capacitor 1a includes a first electric double-layer capacitor element 31a enclosed in a package 31c and a second electric double-layer capacitor element 31b. Each of the first and second electric double-layer capacitor elements 31a and 31b has a rectangular shape whose longitudinal direction is parallel to the x-axis direction (second direction). The first electric double-layer capacitor element 31a and the second electric double-layer capacitor element 31b are arranged along the x-axis direction. Therefore, the package 31c also has a rectangular shape whose longitudinal direction is parallel to the x-axis direction.

The package 31c is provided with a rectangular first cell 31c1 and a rectangular second cell 31c2 adjacent to the first cell 31c1 in the x-axis direction. A first electric double-layer capacitor element 31a is encapsulated in the first cell 31c1. A second electric double-layer capacitor element 31b is encapsulated in the second cell 31c2.

(Electrolyte)

Each cell 31c1, 31c2 is filled with an electrolyte. The electrolyte includes a cation, an anion, and a solvent. Preferable examples of the cation include tetraethylammonium salt, 5-azoniaspiro[4,4]nonane, and the like. Preferable examples of the anion include tetrafluoroborate ions (BF₄⁻), bis[(trifluoromethyl)sulfonyl]imide ((CF₃SO₂)₂N⁻), and the like. Preferable examples of the solvent include carbonate compounds such as propylene carbonate, ethylene carbonate, diethyl carbonate, and dimethyl carbonate; nitrile compounds; and aqueous solvents such as water.

The electrolyte may be, for example, an ionic liquid containing a crosslinkable gel electrolyte or an imidazole compound.

In the present embodiment, the first electric double-layer capacitor element 31a and the second electric double-layer capacitor element 31b are formed of the same electric double-layer capacitor element 32.

The electric double-layer capacitor element 32 has a first electrode 311, a second electrode 312, and a separator 313.

The first electrode 311 and the second electrode 312 are opposed to each other with the separator 313 interposed therebetween. Specifically, a plurality of first electrodes 311 and a plurality of second electrodes 312 are alternately laminated with the separator 313 interposed therebetween.

(First Electrode 311)

As shown in FIG. 6, the first electrode 311 includes a first current collecting electrode 311a. The first current collecting electrode 311a can be formed of, for example, an aluminum foil or the like. A thickness of the first current collecting electrode 311a can be, for example, about 10 μm or more and 30 μm or less. A first polarizable electrode 311b is provided on the first current collecting electrode 311a.

As shown in FIG. 6, the first electrode 311 has a rectangular positive electrode 311A, an extended part 311B, and a non-opposing part 311C. The positive electrode 311A is opposed to the second electrode 312. Specifically, the positive electrode 311A is opposed to the negative electrode 312A to be described later in the second electrode 312. The positive electrode 311A has a first current collecting electrode (positive electrode side current collecting electrode) 311a and a first polarizable electrode (positive electrode side polarizable electrode) 311b provided on the first current collecting electrode 311a. The first polarizable electrode 311b is provided only on the positive electrode 311A of the first electrode 311.

The positive electrode 311A has a first side 311A1 and a second side 311A2 extending along the y-axis direction (first direction). The positive electrode 311A has a third side 311A3 and a fourth side 311A4 extending along the x-axis direction (second direction).

The extended part 311B is connected to the positive electrode 311A. The non-opposing part 311C is connected to the positive electrode 311A. The extended part 311B and the non-opposing part 311C are formed of the first current collecting electrode 311a. The non-opposing part 311C is a portion of the second electrode 312, which is not opposed to the negative electrode 312A described later. In the present embodiment, the first electrode 311 has three non-opposing parts 311C.

In the present embodiment, an example in which the non-opposing part 311C is provided is described, but the present invention is not limited to this configuration. For example, the first electrode may be formed of a positive electrode and an extended part.

(Second Electrode 12)

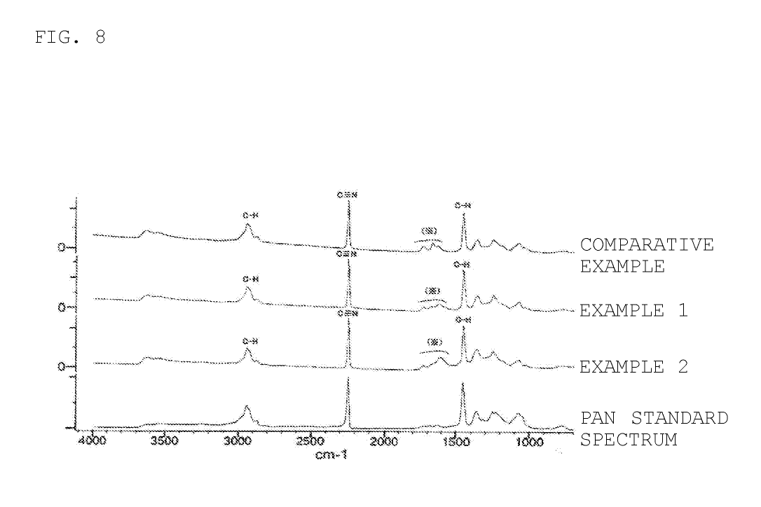

As shown in FIG. 7, the second electrode 312 includes a second current collecting electrode 312a. The second current collecting electrode 312a can be formed of, for example, an aluminum foil or the like. A thickness of the second current collecting electrode 312a can be, for example, about 10 μm or more and 30 μm or less.

A second polarizable electrode 312b is provided on the second current collecting electrode 312a. A thickness of the second polarizable electrode 312b can be, for example, about 10 μm or more and 30 μm or less.

The second electrode 312 has a rectangular negative electrode 312A, an extended part 312B, and a non-opposing part 312C. The negative electrode 312A is opposed to the positive electrode 311A. Specifically, at least a portion of the negative electrode 312A is opposed to the positive electrode 311A. The negative electrode 312A has a second current collecting electrode (negative electrode side current collecting electrode) 312a and a second polarizable electrode (negative electrode side polarizable electrode) 312b provided on the second current collecting electrode 312a. The second polarizable electrode 312b is provided only on the negative electrode 312A of the second electrode 312.

The negative electrode 312A has a first side 312A1 and a second side 312A2 extending along the y-axis direction (first direction). The negative electrode 312A has a third side 312A3 and a fourth side 312A4 extending along the x-axis direction (second direction).

In the present embodiment, the negative electrode 312A is larger than the positive electrode 311A. In other words, the negative electrode 312A has a larger area than the positive electrode 311A. An area of the negative electrode 312A is preferably 1.0 times or more larger than an area of the positive electrode 311A, and is preferably 1.5 times or less, more preferably 1.01 times or more and 1.3 times or less. If a difference between the area of the negative electrode 312A and the area of the positive electrode 311A is too large, a capacitance of the electric double-layer capacitor 1 may be reduced. If the difference between the area of the negative electrode 312A and the area of the positive electrode 311A is too small, a deterioration at the time of voltage application may become faster in some cases.

As described above, since the negative electrode 312A has a larger area than the positive electrode 311A, at least one set of edge sides of the positive electrode 311A and the negative electrode 312A corresponding to each other are different in a position in a plan view. Specifically, in the present embodiment, in a plan view, one set of edge sides corresponding to each other are different in a position, and the other set of edge sides corresponding to each other which are parallel to the one set of edge sides are different in a position. That is, the positions of the first side 311A1 of the positive electrode 311A and the first side 312A1 of the negative electrode 312A are different, the positions of the second side 311A2 of the positive electrode 311A and the second side 312A2 of the negative electrode 312A are different or the positions of the third side 311A3 of the positive electrode 311A and the third side 312A3 of the negative electrode 312A are different, and the positions of the fourth side 311A4 of the positive electrode 311A and the fourth side 312A4 of the negative electrode 312A are different. More specifically, the positive electrode 311A and the negative electrode 312A are provided such that in a plan view, each set of edge sides corresponding to each other are different in a position. That is, the positive electrode 311A and the negative electrode 312A are provided such that the positions of the first side 311A1 and the first side 312A1 are different, the positions of the second side 311A2 and the second side 312A2 are different, the positions of the third side 311A3 and the third side 312A3 are different, and the positions of the fourth side 311A4 and the fourth side 312A4 are different.

In the present embodiment, an example in which the positive electrode 311A has a smaller area than the negative electrode 312A will be described. However, the present invention is not limited to this configuration. For example, the negative electrode may have a smaller area than the positive electrode, or an area of the negative electrode may be the same as an area of the positive electrode.

The extended part 312B and the non-opposing part 312C are each connected to the negative electrode 312A. The extended part 312B and the non-opposing part 312C are each formed of the first current collecting electrode 311a. The non-opposing part 312C is a portion not opposed to the positive electrode 311A. In the present embodiment, the second electrode 312 has three non-opposing parts 312C.

In the present embodiment, an example in which the non-opposing part 312C is provided has been described, but the present invention is not limited to this configuration. For example, the second electrode may be formed of a negative electrode and an extended part.

(Separator 313)

The separator 313 is provided between the first electrode 311 and the second electrode 312 which are neighboring. In the present embodiment, the separator 313 is larger than the positive electrode 311A and the negative electrode 312A. The first electrode 311 and the second electrode 312 are isolated from each other by this separator 313.

A maximum thickness of the separator 313 is preferably 11 μm or more, and more preferably 15 μm or more. By setting the maximum thickness of the separator 313 in the above range, it is possible to prevent a short-circuit failure from occurring when stress is applied to the electric double-layer capacitor 1a. However, if the maximum thickness of the separator 313 is made too large, an internal resistance of the electric double-layer capacitor 1a may increase. Therefore, the maximum thickness of the separator 313 is preferably 26 μm or less, and more preferably 20 μm or less. For the maximum thickness of the separator 13, arbitrary five points were measured with a micrometer C125 XB manufactured by Mitutoyo Corporation, and the maximum value among them was taken as the maximum thickness.

The separator 313 can be formed of, for example, a porous sheet having a plurality of interconnected cells. A void ratio of the separator 313 is preferably 70% or more, and more preferably 80% or more. By setting the void ratio of the separator 313 within the above range, the internal resistance of the electric double-layer capacitor 1a can be reduced. However, when the void ratio of the separator 313 is set too high, a short-circuit failure easily occurs when an external stress is applied to the electric double-layer capacitor 1a. Therefore, the void ratio of the separator 313 is preferably 95% or less, and more preferably 90% or less.

The separator 313 can be formed of, for example, a nonwoven fabric, a woven fabric, or the like. When the separator 313 is formed of a nonwoven fabric or a woven fabric, an average fiber diameter of the fibers is preferably 0.5 μm or less, and more preferably 0.45 μm or less. By setting the average fiber diameter within the above range, the internal resistance of the electric double-layer capacitor 1a can be reduced. However, when the average fiber diameter is too small, the mechanical strength of the separator 313 may be lowered. Therefore, the average fiber diameter is preferably 0.2 μm or more, more preferably 0.25 μm or more.

The separator 313 contains polyacrylonitrile. The separator 313 may further contain components other than polyacrylonitrile. The separator 313 may further contain, for example, a thermally modified product of polyacrylonitrile, polyethylene terephthalate (PET), polyvinyl alcohol (PVA), aramid or the like.

A infrared absorption spectrum of the separator 313 measured by a Fourier transform infrared spectrophotometer has a first peak in a range from 2240 cm⁻¹ to 2250 cm⁻¹. In addition, the infrared absorption spectrum of the separator 313 measured by a Fourier transform infrared spectrophotometer has a second peak in the range from 1580 cm⁻¹ to 1630 cm⁻¹. A ratio of an intensity of the second peak to an intensity of the first peak is 0.08 or more.

As shown in FIG. 5, a first electrode terminal 315 of the first electric double-layer capacitor element 31a is connected to the extended part 311B of the first electrode 311 at a first corner part 31C1 of the first cell 31c1. The first electrode terminal 315 penetrates a sealing part 31C3 of the package 31c and is drawn out to the outside of the first cell 31c1.

A second electrode terminal 316 of the first electric double-layer capacitor element 31a is connected to the extended part 312B of the second electrode 312 at the first corner part 31C1 of the first cell 31c1. The second electrode terminal 316 penetrates the sealing part 31C3 of the package 31c and is drawn out to an outside of the first cell 31c1.

The second electrode terminal 317 of the second electric double-layer capacitor element 31b is connected to the extended part 312C of the second electrode 312 at a second corner part 31C2 of the second cell 31c2. The second electrode terminal 317 penetrates the sealing part 31C3 of the package 31c and is drawn out to the outside of the first cell 31c1. The second electrode terminal 317 is electrically connected to the first electrode terminal 315 through a connecting material 319.

The first electrode terminal 318 of the second electric double-layer capacitor element 31b extends from the extended part 311C of the first electrode 311 toward the y1 side in the y-axis direction at the second corner part 31C2 of the second cell 31c2. The first electrode terminal 318 penetrates the sealing part 31C3 of the package 31c and is drawn out to the outside of the first cell 31c1.

Note that the electric double-layer capacitor 1a according to the present embodiment can be manufactured by substantially the same method as the manufacturing method for the electric double-layer capacitor 1 described in the first embodiment.

As described above, as a result of intensive research, the present inventors have found that by setting the ratio of the intensity of the second peak to the intensity of the first peak in the infrared absorption spectrum of the separator 313 containing polyacrylonitrile to 0.08 or more, the mechanical strength of the separator 313 can be improved, and therefore a desired mechanical strength can be attained even if the separator 313 is thinned. As a result, the present inventors conceived that by setting the ratio of the intensity of the second peak to the intensity of the first peak in the infrared absorption spectrum of the separator 313 containing polyacrylonitrile to 0.08 or more, the separator 313 can be thinned, and therefore it is possible to reduce a thickness of the electric double-layer capacitor 1a.

Furthermore, in the electric double-layer capacitor 1a, the positive electrode 311A and the negative electrode 312A are arranged such that at least one set of edge sides corresponding to each other are different in a position in a plan view. Therefore, when an external stress is applied to the electric double-layer capacitor 1a, the stress hardly concentrates at a specific location of the separator 313. Therefore, the mechanical strength required for the separator 313 is low as compared with the case where the stress concentrates at a specific location of the separator. Therefore, the separator 313 can be thinned. As a result, the electric double-layer capacitor 1a can be made thinner.

From the viewpoint of more effectively suppressing concentration of stress at a specific location of the separator 313 when an external stress is applied to the electric double-layer capacitor 1a, it is more preferred that the positive electrode 311A and the negative electrode 312A are arranged such that in a plan view, one set of edge sides corresponding to each other are different in a position, and the other set of edge sides corresponding to each other which are parallel to the one set of edge sides are different in a position. From the same viewpoint, it is more preferred that the positive electrode 311A and the negative electrode 312A are arranged such that in a plan view, each set of edge sides corresponding to each other are different in a position.

Further, the present inventors have found that the separator 313 containing polyacrylonitrile in which the ratio of the intensity of the second peak to the intensity of the first peak in the infrared absorption spectrum is 0.08 or more is high in thermal durability, and is hardly modified at high temperature. As a result, the present inventors conceived that by setting the ratio of the intensity of the second peak to the intensity of the first peak in the infrared absorption spectrum of the separator 313 containing polyacrylonitrile to 0.08 or more, an electric double-layer capacitor 1a having excellent thermal durability can be realized.

The present invention will be described in more detail below based on specific examples, but the present invention is not limited to the following examples, and variations and modifications may be appropriately made without departing from the gist of the invention.

### Example 1

A nonwoven fabric of polyacrylonitrile having a thickness of 17 μm and an average fiber diameter of 0.3 and formed of a polyacrylonitrile homopolymer was heated at 230° C. for 72 seconds in an oxidizing atmosphere, and used as a separator. Using the resulting separator, an electric double-layer capacitor having substantially the same configuration as the electric double-layer capacitor 1 according to the first embodiment was fabricated.

### Example 2

An electric double-layer capacitor was fabricated in the same manner as in Example 1 except that the separator was prepared with a heating time of the nonwoven fabric of polyacrylonitrile being 120 seconds.

### Comparative Example

An electric double-layer capacitor was fabricated in the same manner as in Example 1 except that a nonwoven fabric of polyacrylonitrile having a thickness of 17 μm and an average fiber diameter of 0.3 μm and formed of a polyacrylonitrile homopolymer was used as a separator without heating.

(Measurement of Infrared Absorption Spectrum)

Infrared absorption spectra of the separators prepared in Examples 1 and 2 and comparative example were measured using Spotlight 400/Frontier manufactured by PerkinElmer, Inc. The results are shown in FIG. 8.

From the results shown in FIG. 8, it can be seen that by heating the nonwoven fabric containing polyacrylonitrile, the second peak becomes large in the range from 1580 cm⁻¹ to 1630 cm⁻¹ with respect to the first peak in the range from 2240 cm⁻¹ to 2250 cm⁻¹. From this, it can be seen that by heating the nonwoven fabric containing polyacrylonitrile, the triple bond between carbon and nitrogen is reduced, and a thermally modified product of polyacrylonitrile is produced.

(Short-Circuit Rate)

100 electric double-layer capacitors having substantially the same configuration as the electric double-layer capacitor 1 according to the first embodiment were prepared and a leakage current was measured after applying a voltage of 2.1 V for 100 hours at room temperature. A short-circuit rate (count number/100) was calculated by counting an electric double-layer capacitor with a leakage current measurement value of 59 μmA or more as a short circuit. The results are shown in Table 1.

TABLE 1

| | | Intensity | |
|---|---|---|---|
| | | of second | Short- |
| | Heating time | peak/intensity of | circuit rate |
| | (sec) | first peak | (%) |
| Example 1 | 72 | 0.084 | 3 |
| Example 2 | 120 | 0.096 | 0 |
| Comparative | 0 | 0.072 | 30 |
| Example | | | |

From the results shown in Table 1, it can be seen that the short-circuit rate of the electric double-layer capacitor was reduced by setting the intensity of the second peak/the intensity of the first peak to 0.08 or more. This is presumably because a molecular structure of polyacrylonitrile strengthened by heating and a tensile elongation of the nonwoven fabric decreased.

### DESCRIPTION OF REFERENCE SYMBOLS

1, 1a: Electric double-layer capacitor
10: Outer case
11, 311: First electrode
12, 312: Second electrode
11A1, 12A1, 311A1, 312A1: First side
11A2, 12A2, 311A2, 312A2: Second side
11A3, 12A3, 311A3, 312A3: Third side
11A4, 12A4, 311A4, 312A4: Fourth side
11A, 311A: Positive electrode
11B, 12B, 311B, 312B: Extended part
11C, 12C, 311C, 312C: Non-opposing part
11a, 311a: First current collecting electrode
11b, 311b: First polarizable electrode
12A, 312A: Negative electrode
12a, 312a: Second current collecting electrode
12b, 312b: Second polarizable electrode
13, 313: Separator
31C1: First corner
31C3: Sealing part
31C2: Second corner
32: Electric double-layer capacitor element
31a: First electric double-layer capacitor element
31b: Second electric double-layer capacitor element
31c: Package
31c1: First cell
31c2: Second cell
315, 318: First electrode terminal
316, 317: Second electrode terminal
319: Connecting material

1. An electric double-layer capacitor comprising:
a positive electrode having a positive current collecting electrode and a positive polarizable electrode provided on the positive current collecting electrode;
a negative electrode opposed to the positive electrode and having a negative current collecting electrode and a negative polarizable electrode provided on the negative current collecting electrode, the positive electrode and the negative electrode being arranged such that at least one set of edge sides corresponding to each other are in a different position in a plan view of the electric double-layer capacitor; and
a separator containing polyacrylonitrile and interposed between the positive polarizable electrode and the negative polarizable electrode and impregnated with an electrolyte, an infrared absorption spectrum of the separator measured by a Fourier transform infrared spectrophotometer has a first peak in a range from 2240 cm⁻¹ to 2250 cm⁻¹ and a second peak in a range from 1580 cm⁻¹ to 1630 cm⁻¹, and a ratio of an intensity of the second peak to an intensity of the first peak is 0.08 or more.

2. The electric double-layer capacitor according to claim 1, wherein two sets of edge sides corresponding to each other and which are parallel to each other are in different positions in the plan view of the electric double-layer capacitor.

3. The electric double-layer capacitor according to claim 1, wherein all sets of edge sides corresponding to each other are in different positions in the plan view of the electric double-layer capacitor.

4. The electric double-layer capacitor according to claim 1, wherein the separator is larger than each of the positive electrode and the negative electrode.

5. The electric double-layer capacitor according to claim 1, wherein a thickness of the separator is 11 μm to 26 μm.

6. The electric double-layer capacitor according to claim 1, wherein an area of the negative electrode is 1.0 to 1.5 times larger than an area of the positive electrode.

7. The electric double-layer capacitor according to claim 1, wherein an area of the negative electrode is 1.01 to 1.3 times larger than an area of the positive electrode.

8. The electric double-layer capacitor according to claim 1, wherein a thickness of the separator is 11 μm to 26 μm.

9. The electric double-layer capacitor according to claim 1, wherein a thickness of the separator is 15 μm to 20 μm.

10. The electric double-layer capacitor according to claim 1, wherein the separator is a porous sheet having a plurality of interconnected cells and has a void ratio of 70% to 95%.

11. The electric double-layer capacitor according to claim 1, wherein the separator is a porous sheet having a plurality of interconnected cells and has a void ratio of 80% to 90%.

12. The electric double-layer capacitor according to claim 1, wherein the separator is a formed of a fabric material having an average fiber diameter of 0.2 μm to 0.5 μm.

13. The electric double-layer capacitor according to claim 1, wherein the separator is a formed of a fabric material having an average fiber diameter of 0.25 μm to 0.45 μm.

14. A method for manufacturing an electric double-layer capacitor, the method comprising:
heating a separator containing polyacrylonitrile;
laminating a positive electrode, the heated separator, and a negative electrode such that edge side positions on at least the same side of the positive electrode and the negative electrode are in different positions from each other in a plan view of the electric double-layer capacitor to prepare a laminated body; and
impregnating the heated separator with an electrolyte.

15. The method for manufacturing the electric double-layer capacitor according to claim 13, wherein an infrared absorption spectrum of the separator measured by a Fourier transform infrared spectrophotometer has a first peak in a range from 2240 cm⁻¹ to 2250 cm⁻¹ and a second peak in a range from 1580 cm⁻¹ to 1630 cm⁻¹, and a ratio of an intensity of the second peak to an intensity of the first peak is 0.08 or more.

16. The method for manufacturing the electric double-layer capacitor according to claim 13, wherein the positive electrode, the heated separator and the negative electrode are laminated such that two sets of edge sides corresponding to each other and which are parallel to each other are in different positions in the plan view of the electric double-layer capacitor.

17. The method for manufacturing the electric double-layer capacitor according to claim 13, wherein the positive electrode, the heated separator and the negative electrode are laminated such that all sets of edge sides corresponding to each other are in different positions in the plan view of the electric double-layer capacitor.

18. The method for manufacturing the electric double-layer capacitor according to claim 13, wherein the separator is larger than each of the positive electrode and the negative electrode.

19. The method for manufacturing the electric double-layer capacitor according to claim 13, wherein a thickness of the separator is 11 μm to 26 μm.

20. The method for manufacturing the electric double-layer capacitor according to claim 13, wherein an area of the negative electrode is 1.0 to 1.5 times larger than an area of the positive electrode.
